(19) United States
(12) Patent Application Publication
(10) Pub. No.: US 2014/0352208 A1
(43) Pub. Date: Dec. 4, 2014

(54) Grass Protector

(71) Applicant: John Makropoulos, Plainfield, IL (US)

(72) Inventor: John Makropoulos, Plainfield, IL (US)

(21) Appl. No.: 14/287,800

(22) Filed: May 27, 2014

Related U.S. Application Data
(60) Provisional application No. 61/828,541, filed on May 29, 2013.

(51) Int. Cl. A01G 13/00

(52) U.S. Cl. CPC A01G 13/0293
USPC 47/31.1

(57) ABSTRACT

A cover is provided for protecting grass from sun damage. The cover is perforated to allow an optimal amount of sunlight to reach the underlying grass, as well as allowing water to reach the grass. The cover is secured to the ground by inserting an anchor through an anchor hole of the cover. The anchor has a restraining portion that clamps down on the cover and prevents shifting of the cover. To protect large areas, multiple covers can be connected to each other to effectively form a single larger cover. Latching assemblies are positioned at each side of each protective cover, with a latch and latch receptacle making up the latching assembly. The latch and latch receptacle of a reference cover engage with the latch receptacle and latch of an adjacent cover to attach the two covers to each other. This process can be repeated to cover even larger areas.

The current application claims a priority to the U.S. Provisional Patent application Ser. No. 61/828,541 filed on May 29, 2013.

### FIELD OF THE INVENTION

The present invention relates generally to a perforated panel for protecting grass against overexposure to sun while still allowing moisture to reach the grass.

### BACKGROUND OF THE INVENTION

Many homeowners have a lawn to maintain along with their house. Ideally, the grass will have a healthy green appearance, but often times there are spots that appear brown and unhealthy. Homeowners have grown to accept that their lawns have “trouble areas” and have been conditioned to treat said trouble areas with watering, planting seeds, and application of fertilizer. Yet, even with these treatments, lawns still develop brown and patchy spots in the summer season. These spots develop due to overexposure to sunlight. In the northern hemisphere this often occurs on grass which is located to the south of residential and commercial properties; since the sun travels across the southern sky in the northern hemisphere, grass located north of buildings is naturally shaded. While the opposite holds true in the southern hemisphere, the end result is the same regardless of location. Overexposure to sun is detrimental to the health of grass.

It is therefore an object of the present invention to provide an easily utilized apparatus that protects isolated areas of a lawn from overexposure to the sun. It is a further object of the present invention to provide an apparatus that prevents birds from consuming grass seed. It is a further object of the present invention to prevent children and pets from stepping in isolated areas where fertilizer has been applied. It is a final further object of the present invention to allow rain and water through, creating moisture in the solid in order to promote healthy grass.

### BRIEF DESCRIPTION OF THE DRAWINGS

FIG. 1 is a perspective view of one configuration for adjacent protective covers of the present invention.

FIG. 2 is a top view of one configuration for adjacent protective covers of the present invention.

FIG. 3 is a perspective view of an individual protective cover of the present invention.

FIG. 4 is a top view of an individual protective cover of the present invention.

FIG. 5 is a top view of an alternative configuration for adjacent protective covers of the present invention.

FIG. 6 is a perspective view of an anchor of the present invention.

FIG. 7 is a perspective view showing a configuration with four protective covers of the present invention.

### DETAIL DESCRIPTIONS OF THE INVENTION

All illustrations of the drawings are for the purpose of describing selected versions of the present invention and are not intended to limit the scope of the present invention.

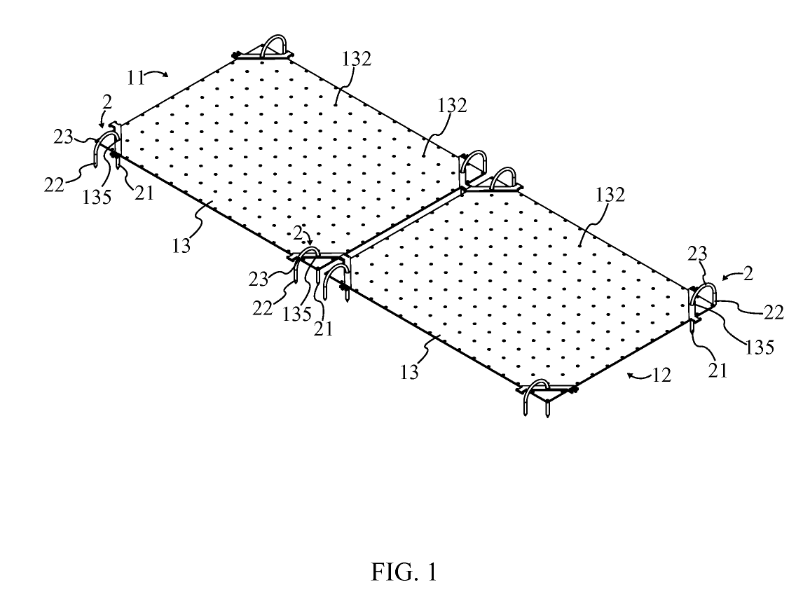

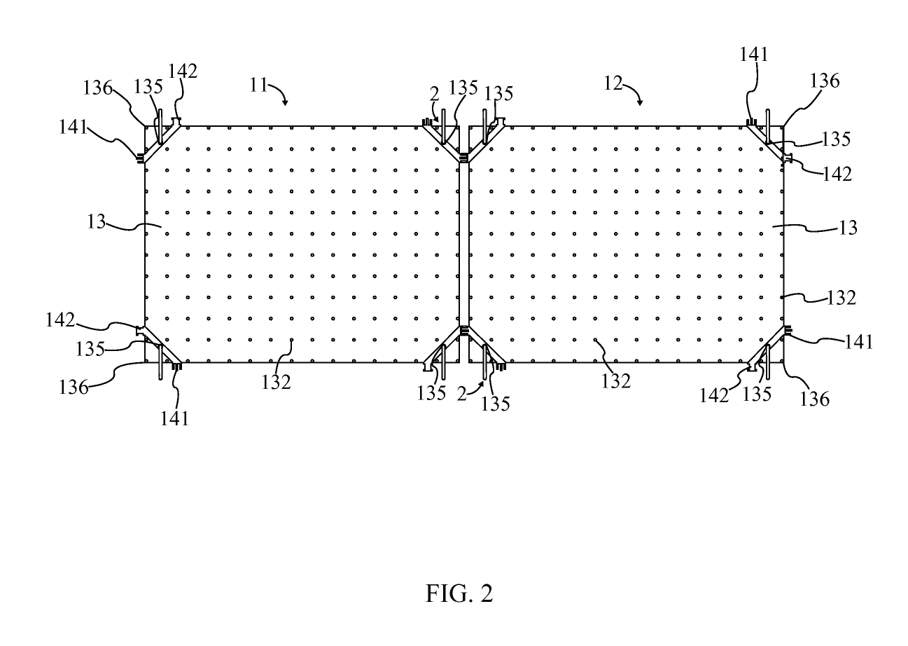

The present invention is an apparatus for protecting grass from the damage that results from overexposure to sunlight. The present invention comprises a plurality of protective covers 1 and a plurality of anchors 2. Each of the plurality of protective covers 1 can be joined to cover areas that are larger than a single protective cover 1 and are secured to the ground through the plurality of anchors 2. Joining of the plurality of protective covers 1 is accomplished by selecting a reference protective cover 11 and attaching to it an adjacent protective cover 12. This modular aspect allows the plurality of protective covers 1 to be used for variable sized areas, with individual protective covers 11 being held in place by the plurality of anchors 2. Thus the present invention can be used for differing sizes of lawns or patches of grass, with the plurality of anchors 2 preventing movement of the plurality of protective covers 1 by winds, animals, or other external forces. General illustrations of the present invention are provided through FIG. 1 and FIG. 2.

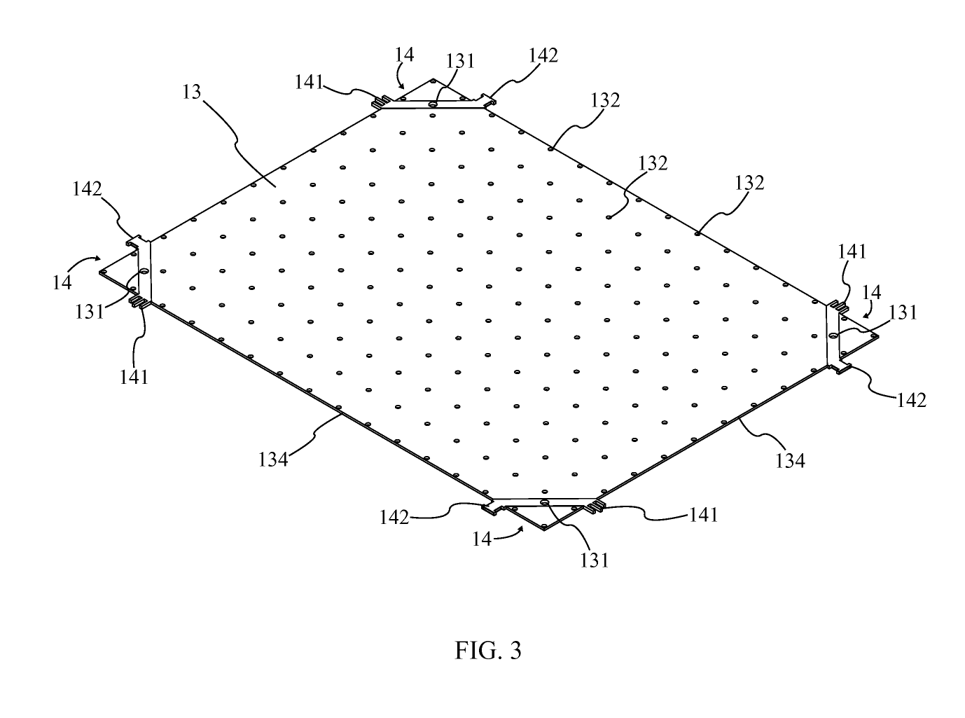

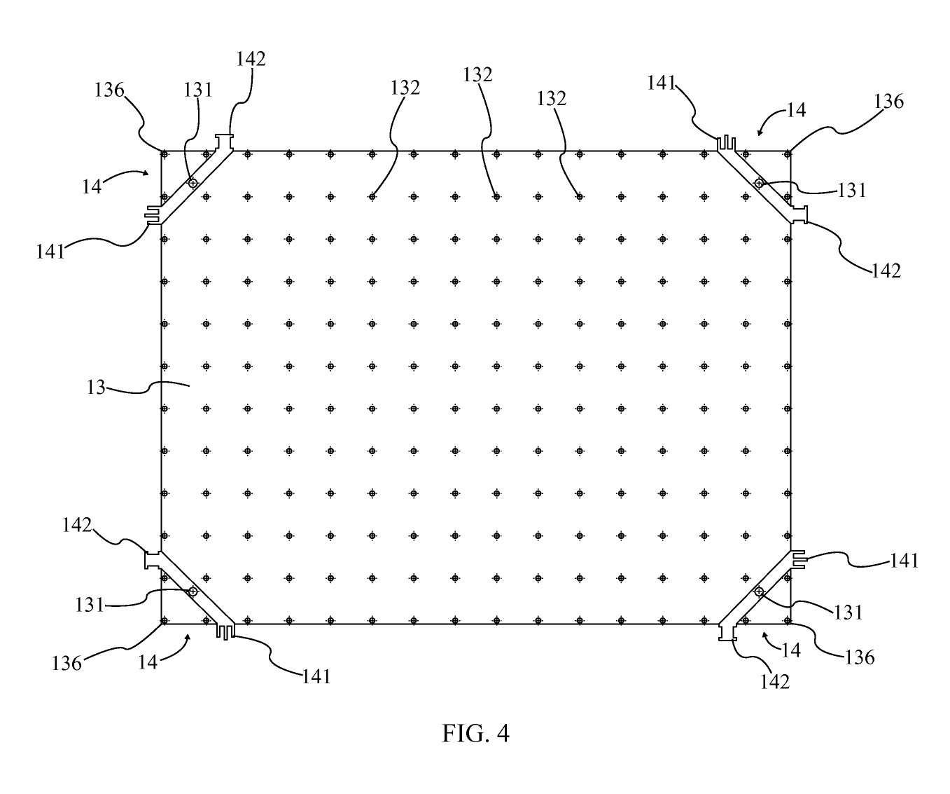

Each of the plurality of protective covers 1 comprises a planar body 13 and a plurality of latching assemblies 14, as shown in FIG. 3 and FIG. 4. The planar body 13 itself comprises a plurality of anchor holes 131 and a plurality of perforations 132. The individual anchor holes 131 are provided as receptacles for the individual anchors 2, allowing an anchor 2 to be inserted into the ground through one of the anchor holes 131. The plurality of perforations 132 is provided to allow some sunlight to reach the ground below the protective cover 1; while the present invention is meant to protect against overexposure, there is still a desirable amount of sunlight exposure which is allowed through the plurality of perforations 132. The plurality of perforations 132 also allows water to reach the underlying grass, regardless of the source of the water (e.g. rain, a watering pot, a hose, or dew). The plurality of perforations 132 is thus patterned along and across the planar body 13 in order to allow a uniform amount of sunlight to reach the area under the protective cover 1. Uniform exposure is preferable as it ensures that there are not discrepancies in the amount of sunlight that reaches the areas under the protective covers 1. Potentially, the planar body 13 can be made into a removable insert that is attached to a panel frame. This would allow users to swap out different sizes and patterns of perforations 132 that may be better suited to their specific lawn.

The plurality of latching assemblies 14 is used to interconnect each of the plurality of protective covers 1, and thus the plurality latching assemblies 14 is connected about the perimeter of the planar body 13. By engaging adjacent latching assemblies 14, an adjacent protective cover 12 can be attached to a selected reference protective cover 11. Additional protective covers 1 may be attached, joining to cover a larger area and allowing the invention to be adaptable to different sizes of lawns or similar terrains which are to be protected.

To allow the adjacent protective cover 12 to be attached to the reference protective cover 11, each of the plurality of latching assemblies 14 comprises a latch 141 and a latch receptacle 142. Additionally, each of the plurality of latching assemblies 14 is mounted to a lateral face of the planar body 13, with at least one latching assembly 14 being provided for each lateral face of the planar body 13. The latch 141 and latch receptacle 142 are positioned such that when the adjacent protective cover 12 is aligned with the reference protective cover 11, their lateral faces match up to allow the latch 141 of the reference protective cover 11 to engage with the latch receptacle 142 of the adjacent protective cover 12. Likewise, the latch 141 of the adjacent protective cover 12 is engaged with the latch receptacle 142 of the reference protective cover 11. With the latches 141 thus engaged, the adjacent protective cover 12 is secured to the reference protective cover 11. Resultantly, a larger area of grass can be protected than if a single protective cover 1 was used.

In the preferred embodiment there is a single latching assembly 14 positioned on a corresponding lateral face, such that the total number of latching assemblies 14 is equal to the total number of lateral faces. The latch 141 and latch receptacle 142 are positioned at opposite ends of the corresponding lateral face. This positioning helps provide a more secure coupling between protective covers 1 as it effectively creates multiple connection points for each corresponding lateral face without requiring the use of multiple latching assemblies 14 on each corresponding lateral face. The positioning also makes the latch 141 and latch receptacle 142 easier for a user to access. If the latch 141 and latch receptacle 142 were instead centered on the corresponding lateral face then a user would have to reach over half the length of the corresponding lateral face to attach the adjacent protective cover 12 to the reference protective cover 11. The user is unable to stand between the adjacent protective cover 12 and the reference protective cover 11 as that would prevent the two protective covers 1 from being attached to each other.

As the present invention is intended to be able to cover a range of areas, the ability to attach the adjacent protective cover 12 to the reference protective cover 11 is an important attribute. To assist with this the present invention utilizes the concept of tessellation. Simply described, tessellation is an arrangement of geometric shapes used to create a larger structure. The present invention applies this by arranging and joining the planar bodies 13 to adjust for and cover different shapes and sizes of lawns. Preferably, the planar body 13 is a polygon shape, with the planar body 13 of each protective cover 1 (e.g. the reference protective cover 11 and the adjacent protective cover 12) being arranged in a tessellated configuration. More specifically, the polygon shape is either a triangle, a rectangle, or a hexagon. These polygon shapes are preferable as they can be used to create regular tessellations; a regular tessellation is one in which every edge of a geometric shape is perfectly aligned with an edge of an adjacent geometric shape. Through the application of a regular tessellation the present invention can maximize coverage, as any potential gaps between neighboring protective covers 1 can be minimized and potentially even eliminated.

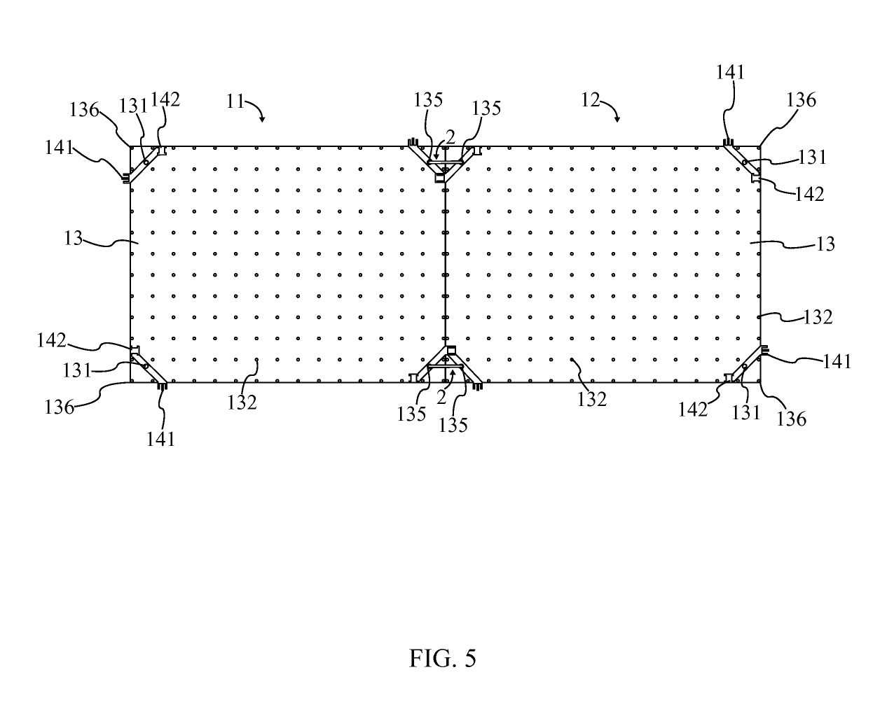

To eliminate the gap between the adjacent protective cover 12 and the reference protective cover 11, the two respective planar bodies 13 must be flush with each other. The planar body 13 comprises a plurality of lateral faces 134, with one of the lateral faces 134 of the adjacent protective cover 12 being pressed against one of the lateral faces 134 of the reference protective cover 11. This configuration effectively results in an aggregated planar surface which spans the desired area to be covered, along with the corresponding advantages such as uniform coverage. An illustration of this configuration is provided in FIG. 5.

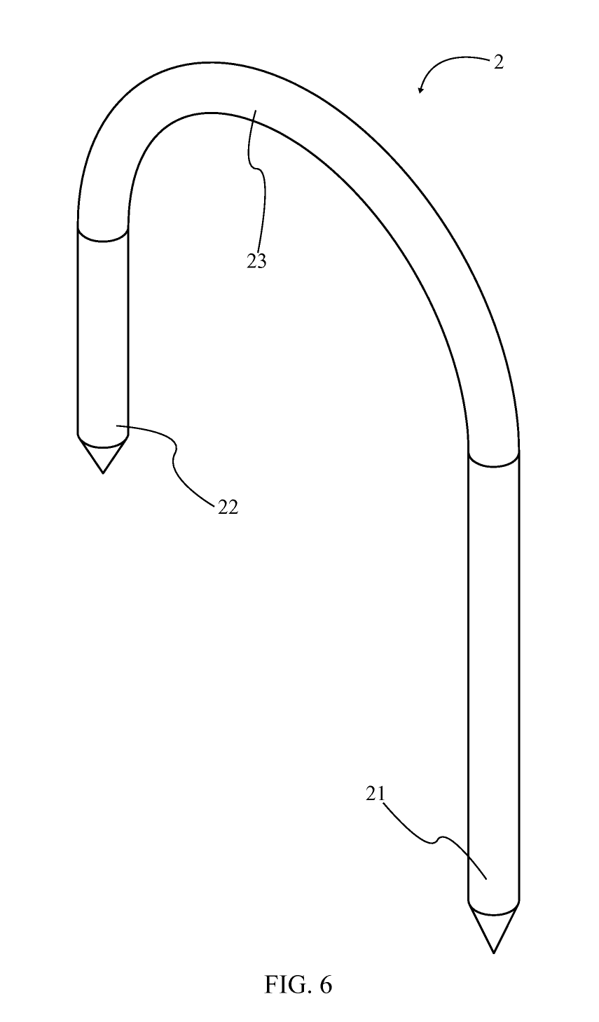

Each of the plurality of anchors 2, which are used to fix each of the plurality of protective covers 1 with respect to the ground, comprises a first end 21, a second end 22, and a restraining portion 23, shown together in FIG. 6. The first end 21 and second end 22 are designed to be staked into the ground, and thus are preferably parallel to each other to make it easier for a user to stake each anchor 2 into the ground. These two ends are connected to each other by the restraining portion 23, which remains above ground and is situated above the planar body 13; the restraining portion 23 effectively clamps down on the planar body 13 and prevents undesired movement. In the preferred embodiment, the shape of each anchor 2 is that of a candy cane, with an arced portion (i.e. the restraining portion 23) being positioned between the two straight portions (i.e. the first end 21 and the second end 22). The restraining portion 23 is also beneficial as it serves as a convenient handle, making it easier for a user to insert or remove the anchor 2 from the ground.

In order to secure the planar body 13 to the ground, each of the plurality of anchors 2 traverses through a corresponding anchor hole 135 from the plurality of anchors holes 131. Preferably, this is accomplished by inserting the first end 21 of an anchor 2 through the corresponding anchor hole 135 and staking the first end 21 into the ground. By doing this for each anchor hole 131 of the reference protective cover 11, a user is able to secure the reference protective cover 11 in place. The second end 22 can be directly staked into the ground, or potentially be used to help secure the adjacent protective cover 12. The exact configuration of the second end 22 depends on the specific configuration of the reference protective cover 11 and the adjacent protective cover 12. If the reference protective cover 11 and adjacent protective cover 12 are placed with a gap between them, then the second end 22 is staked into the ground between the planar bodies 13 of the reference protective cover 11 and the adjacent protective cover 12. Potentially, provided a large enough anchor 2 that can span the gap, the second end 22 could be inserted into a corresponding anchor hole 135 of the adjacent protective cover 12, but preferably each anchor 2 will only be used for one corresponding anchor hole 135.

Alternatively, in a configuration where the reference protective cover 11 and the adjacent protective cover 12 are flush with each other, without a separating gap, the plurality of anchors 2 can be used to secure both the reference protective cover 11 and the adjacent protective cover 12. As with the previous configuration in which there is a gap, the first end 21 traverses through a corresponding anchor hole 135 of the reference protective cover 11. The second end 22, instead of being positioned in the gap, traverses through an adjacent and corresponding anchor hole 135 of the adjacent protective cover 12. The restraining portion 23, which connects the two ends, spans from the reference protective cover 11 to adjacent protective cover 12. The restraining portion 23 clamps down upon the planar body 13 of the reference protective cover 11 and the adjacent protective cover 12, preventing undesired movement.

The positioning of the plurality of anchor holes 131 is closely related to the shape of the planar body 13. As the planar body 13 is preferably a polygon shape, the latter of which comprises a plurality of vertices 136, each of the plurality of anchor holes 131 is positioned at a corresponding vertex selected from the plurality of vertices 136. As an example, if the polygon shape is a triangle, there are three vertices 136 and thus three anchor holes 131, with a single anchor hole 131 being positioned at a corresponding vertex. If the polygon shape were a square or hexagon then there would be four or six vertices 136, respectively. Thus a square-shaped planar body 13 would have four anchor holes 131 while a hexagon-shaped planar body 13 would have six anchor holes 131. While the preferred embodiment places a single anchor hole 131 at each vertex 136, alternative embodiments may choose to place multiple anchor holes 131 at each vertex 136, to change the positioning of the anchor holes 131 (e.g. between and collinear with an adjacent pair of vertices 136), or a combination thereof.

While the preferred embodiment describes a core set of components and configurations therefore, substitutions and alterations may be made without deviating from the scope of the present invention. For example, while the latch 141 and latch receptacle 142 in the preferred embodiment are the male and female portions of a snap buckle, alternative embodiments may implement different latching assemblies 14. Magnets, hook-and-loop fasteners (commonly referred to by the trademarked name of Velcro), and even spring-loaded pins are just a few non-limiting examples of mechanisms that may be used in place of a snap buckle. Ultimately, while a number of mechanisms can be utilized for the latching assembly 14, the best options will be low cost and weather resistant.

The latching assemblies 14 are preferably positioned atop the planar body 13 to make it easier for a user to engage and disengage a latch 141 from a latch receptacle 142. As previously discussed, the latch receptacle 142 may protrude past the perimeter of the planar body 13 (resulting in a gap between the reference protective cover 11 and the adjacent protective cover 12) or instead be positioned within the perimeter of the planar body 13 (resulting in the reference protective cover 11 and the adjacent protective cover 12 being flush with each other).

While the preferred embodiment of the present invention uses a polypropylene material (as used with trampolines) for construction of the planar body 13, other embodiments may substitute different light-obstructing materials. The dimensions of the planar body 13 are variable, with specific dimensions varying based on the polygon shape utilized and the preferences of the manufacturer. Ideal dimensions will create a planar body 13 which is not so large as to be unwieldy and difficult to install, but not so small as to require a large number of protective covers 1 to cover even small areas. In the preferred embodiment the planar body 13 is a four foot by six foot rectangle or a four foot by four foot square.

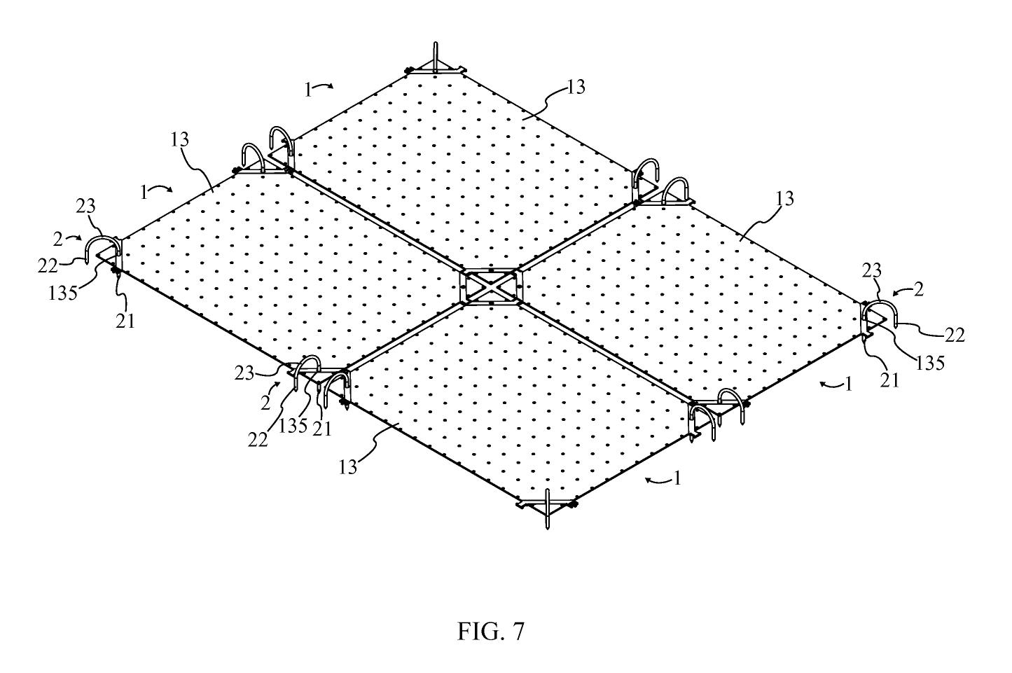

To use the present invention a person begins by placing one of the plurality of protective covers 1 on the ground, which now serves as the reference protective cover 11. This reference protective cover 11 is secured to the ground by inserting one of the plurality of anchors 2 through each of the anchor holes 131; more specifically, the first end 21 of the anchor 2 goes through a corresponding anchor hole 135 and pierces the ground while the second end 22 of the anchor 2 is positioned outside the perimeter of the planar body 13 and simply pierces the ground without traversing through an anchor hole 131. Thus, provided a square planar body 13, there are four anchors 2 that secure the reference protective cover 11 to the ground. A second protective cover 1 is taken from the plurality of protective covers 1 and serves as the active adjacent protective cover 12. The adjacent protective cover 12 is positioned next to the reference protective cover 11, such that two of their sides line up, and is attached by engaging the aligned latches 141 and latch receptacles 142. After the adjacent protective cover 12 has been attached to the reference protective cover 11, it can then be anchored to the ground by inserting an anchor 2 through each of the anchor holes 131 of the adjacent protective cover 12. This is accomplished in the same manner as with the reference protective cover 11, with four anchors being used to secure the square planar body 13 to the ground. This process can be repeated to attach additional protective covers 1 to the first two protective covers 1, allowing a user to protect any size and shape of lawn with the use of the additional protective covers 1. FIG. 7 shows an example configuration of the present invention that utilizes 4 protective covers 1.

A variation to the above process is necessary when the protective covers 1 are positioned to be flush with each other, with no gap between neighboring protective covers 1. In this variation the neighboring protective covers 1 must first be positioned next to and attached to each other before being anchored to the ground. The attachment process is the same, while the anchoring process is mostly similar except that anchors 2 are shared between the reference protective cover 11 and the adjacent protective cover 12. This is done by inserting the first end 21 into the ground through a corresponding anchor hole 131 of the reference protective cover 11 and inserting the second end 22 into the ground through a corresponding anchor hole 135 of the adjacent protective cover 12. In this manner one anchor 2 can be used to help secure two protective covers 1.

The present invention not only protects grass from damage due to sun exposure, it also can be used to protect children and pets from stepping in areas where fertilizer or other potentially dangerous treatments were used. Another benefit is that birds are prevented from eating grass seeds, allowing more seeds to germinate and ultimately resulting in a healthier lawn. Through use of the present invention a user has the potential to save money by reducing or eliminating the need for fertilizer, seeds, and watering of the lawn. The present invention may be used until a protected area recovers from overexposure and returns to a healthy state, at which point the anchors may be removed, the panels disconnected from each other, and the present invention placed in storage.

Although the invention has been explained in relation to its preferred embodiment, it is to be understood that many other possible modifications and variations can be made without departing from the spirit and scope of the invention as hereinafter claimed.

What is claimed is:

1. A grass protector comprises:
a plurality of protective covers comprises a reference protective cover and an at least one adjacent protective cover;
a plurality of anchors;
each of the plurality of protective covers comprises a planar body and a plurality of latching assemblies;
the planar body comprises a plurality of anchor holes and a plurality of perforations;
the plurality of anchor holes and the plurality of perforations traversing through the planar body;
the plurality of anchor holes being perimetrically positioned around the planar body;
the plurality of perforations being distributed along and across the planar body;
each of the plurality of anchors traversing through a corresponding anchor hole from the plurality of anchor holes;
the plurality of latching assemblies being perimetrically connected around the planar body; and
the adjacent protective cover being adjacently attached to the reference protective cover.

2. The grass protector as claimed in claim 1 comprises:
each of the plurality of latching assemblies comprises a latch and a latch receptacle;
each of the plurality of latching assemblies being mounted to a corresponding lateral face of the planar body;
the latch of the corresponding lateral face for the reference protective cover being engaged with the latch receptacle of the corresponding lateral face for the adjacent protective cover; and
the latch of the corresponding lateral face for the adjacent protective cover being engaged with the latch receptacle of the corresponding lateral face for the reference protective cover.

3. The grass protector as claimed in claim 2 comprises:
the latch and the latch receptacle being positioned opposite each other along the corresponding lateral face.

4. The grass protector as claimed in claim 1 comprises:
the planar body being a polygon shape; and
the planar body of the reference protective cover and the planar body of the adjacent protective cover being arranged in a tessellated configuration.

5. The grass protector as claimed in claim 4 comprises:
the polygon shape being selected from the group consisting of: a triangle, a rectangle, and a hexagon.

6. The grass protector as claimed in claim 1 comprises:
the planar body being a polygon shape, wherein the polygon shape comprises a plurality of vertices; and
each of the plurality of anchor holes being positioned at a corresponding vertex from the plurality of vertices.

7. The grass protector as claimed in claim 1 comprises:
the planar body comprises a plurality of lateral faces; and
one of the plurality of lateral faces for the adjacent protective cover being pressed against one of the plurality of lateral faces for the reference protective cover.

8. The grass protector as claimed in claim 1 comprises:
each of the plurality of anchors comprises a first end, a second end, and a restraining portion;
the first end and the second end being parallel to each other;
the first end and the second end being connected to each other by the restraining portion; and
the first end traversing through one of the plurality of anchor holes of the reference protective cover.

9. The grass protector as claimed in claim 8 comprises:
the second end traversing through one of the plurality of anchor holes of the adjacent protective cover.

10. A grass protector comprises:
a plurality of protective covers comprises a reference protective cover and an at least one adjacent protective cover;
a plurality of anchors;
each of the plurality of protective covers comprises a planar body and a plurality of latching assemblies;
the planar body comprises a plurality of anchor holes and a plurality of perforations;
the plurality of anchor holes and the plurality of perforations traversing through the planar body;
the plurality of anchor holes being perimetrically positioned around the planar body;
the plurality of perforations being distributed along and across the planar body;
each of the plurality of anchors traversing through a corresponding anchor hole from the plurality of anchor holes;
the planar body being a polygon shape wherein the polygon shape comprises a plurality of vertices;
each of the plurality of latching assemblies comprises a latch and a latch receptacle;
the plurality of latching assemblies being perimetrically connected around the planar body; and
the adjacent protective cover being adjacently attached to the reference protective cover.

11. The grass protector as claimed in claim 10 comprises:
each of the plurality of latching assemblies being mounted to a corresponding lateral face of the planar body;
the latch of the corresponding lateral face for the reference protective cover being engaged with the latch receptacle of the corresponding lateral face for the adjacent protective cover;
the latch of the corresponding lateral face for the adjacent protective cover being engaged with the latch receptacle of the corresponding lateral face for the reference protective cover; and
the latch and the latch receptacle being positioned opposite each other along the corresponding lateral face.

12. The grass protector as claimed in claim 10 comprises:
the planar body of the reference protective cover and the planar body of the adjacent protective cover being arranged in a tessellated configuration.

13. The grass protector as claimed in claim 10 comprises:
the polygon shape being selected from the group consisting of: a triangle, a rectangle, and a hexagon.

14. The grass protector as claimed in claim 10 comprises:
each of the plurality of anchor holes being positioned at a corresponding vertex from the plurality of vertices.

15. The grass protector as claimed in claim 10 comprises:
the planar body comprises a plurality of lateral faces; and
one of the plurality of lateral faces for the adjacent protective cover being pressed against one of the plurality of lateral faces for the reference protective cover.

16. The grass protector as claimed in claim 10 comprises:
each of the plurality of anchors comprises a first end, a second end, and a restraining portion;
the first end and the second end being parallel to each other;
the first end and the second end being connected to each other by the restraining portion; and
the first end traversing through one of the plurality of anchor holes of the reference protective cover.

17. The grass protector as claimed in claim 16 comprises:
the second end traversing through one of the plurality of anchor holes of the adjacent protective cover.
